(19) United States
(12) Patent Application Publication
(10) Pub. No.: US 2021/0366488 A1
(43) Pub. Date: Nov. 25, 2021

(54) Speaker Identification Method and Apparatus in Multi-person Speech

(71) Applicant: SHENZHEN EAGLESOUL TECHNOLOGY CO., LTD., Shenzhen (CN)

(72) Inventors: Qiwei LU, Pu'ning (CN); Shanguo LIU, Dalian (CN); Jia LIU, (CN)

(21) Appl. No.: 16/467,845

(22) PCT Filed: Mar. 9, 2018
(86) PCT No.: PCT/CN2018/078530

§ 371 Date: Jun. 7, 2019

(30) Foreign Application Priority Data
Feb. 1, 2018 (CN) 201810100768.4

(51) Int. Cl. G10L 17/02; G10L 25/27; G10L 17/16; G10L 25/51

(52) U.S. Cl. CPC G10L 17/02; G10L 25/51; G10L 17/16; G10L 25/27

(57) ABSTRACT

The present disclosure relates to a speaker identification method and apparatus in a multi-person speech, and an electronic device and a storage medium, and relates to the technical field of computers. The method comprises: acquiring speech contents in a multi-person speech; extracting and processing a harmonics band in a voice segment of a pre-set length from the speech contents; making a calculation and analysis of the number of harmonics in the harmonics band and their relative strengths so as to determine the same speaker accordingly; identifying, by analyzing speech contents corresponding to different speakers, identity information about each of the speakers; and finally generating a corresponding relationship between the speech contents of the different speakers and the identity information about the speakers. The present disclosure can effectively distinguish identity information about speakers according to their speech contents.

### CROSS-REFERENCE TO RELATED APPLICATIONS

This application is a national stage application of PCT Application No. PCT/CN2018/078530. This application claims priority from PCT Application No. PCT/CN2018/078530, filed Mar. 9, 2018, and CN Application No. 201810100768.4, filed Feb. 1, 2018, the content of which is incorporated herein in the entirety by reference.

Some references, which may include patents, patent applications, and various publications, are cited and discussed in the description of the present disclosure. The citation and/or discussion of such references is provided merely to clarify the description of the present disclosure and is not an admission that any such reference is “prior art” to the present disclosure described herein. All references cited and discussed in this specification are incorporated herein by reference in their entireties and to the same extent as if each reference was individually incorporated by reference.

### TECHNICAL FIELD

The present disclosure relates to the technical field of computers, and in particular to a speaker identification method and apparatus in a multi-person speech, and an electronic device and a computer readable storage medium.

### BACKGROUND ART

At present, recording events via electronic devices, such as recording audio or recording video, has brought great convenience to daily life. For example, making audio and video recordings of teacher's lectures in class facilitates the teaching of the teachers again or revision of lessons by students; or, in a conference, live television watching and other occasions, the use of an electronic device to record audio and video facilitates playback or electronic data archiving, referring and so on.

However, when there are many people speaking in the audio and video files, for unfamiliar people or voices it is not possible to identify information about the current speaker or all speakers based only on the face or voice, or when a conference file needs to be formed, it is necessary to play back the recording and identify the voice by oneself to identify the corresponding speaker of each audio, and if the speaker is relatively strange, it is also extremely easy to occur identification errors and other circumstances.

Therefore, there is a need to provide one or more technical solutions that can at least solve the above problems.

It should be noted that the information disclosed in the background art section above is used only to enhance the understanding of the background of the present disclosure, and thus may include information that does not constitute the prior art that is known to a person skilled in the art.

Therefore, a heretofore unaddressed need exists in the art to address the aforementioned deficiencies and inadequacies.

### SUMMARY OF THE INVENTION

The purpose of the present disclosure is to provide a speaker identification method and apparatus in a multi-person speech, and an electronic device and a computer readable storage medium, so as to overcome, at least to a certain extent, one or more problems caused by the limitations and defects of the relevant technologies.

According to one aspect of the present disclosure, a speaker identification method in a multi-person speech is provided, the method comprising:

acquiring speech contents in a multi-person speech, extracting a voice segment of a pre-set length from the speech contents, and performing de-fundamental wave processing on the voice segment to obtain a harmonics band of the voice segment;

detecting the harmonics band in the voice segment of the pre-set length, calculating the number of harmonics during the detection, and analyzing the relative strengths of the various harmonics;

marking voices that have the same number of harmonics and the same strength of harmonics in different detection periods to be of the same speaker;

identifying, by analyzing speech contents corresponding to different speakers, identity information about each of the speakers; and

generating a corresponding relationship between the speech contents of the different speakers and the identity information about the speakers.

In one exemplary embodiment of the present disclosure, the method further comprises: identifying, by analyzing speeches corresponding to different speakers, identity information about each of the speakers comprises:

inputting the speeches of the different speakers into a voice recognition model so as to identify word features that have the identity information; and

performing semantic analysis on the word features that have the identity information in combination with a sentence that the word features are in, so as to determine identify information about the current speaker or speakers in other time periods.

In one exemplary embodiment of the present disclosure, inputting speeches of the different speakers into a voice recognition model so as to identify word features that have the identity information comprises:

muting the speech audio of the different speakers and cutting same;

framing the speeches of the different speakers at a pre-set frame length and a pre-set length of frame shifts, so as to obtain a voice segment of a pre-set frame length; and

extracting acoustic features of the voice segment by using a Hidden Markov model λ=(A, B, π), so as to identify the word features that have the identity information, where A is an implicit state transition probability matrix; B is an observation state transition probability matrix; and π is an initial state probability matrix.

In one exemplary embodiment of the present disclosure, the method further comprises: identifying, by analyzing speeches corresponding to different speakers, identity information about each of the speakers comprises:

searching, on the Internet, for voice files that have the same number of harmonics and strength of harmonics as those of the speaker in the detection period; and

searching for bibliographic information about the voice files, and determining identity information about the speaker according to the bibliographic information.

In one exemplary embodiment of the present disclosure, the method further comprises: after the identification of the identity information about the various speakers, the method further comprises:

searching, on the Internet, for the social status and position corresponding to the various speakers; and

according to the social status and position of the speakers, determining a speaker who has the highest matching degree with the current conference theme to be a core speaker.

In one exemplary embodiment of the present disclosure, the method further comprises:

collecting response information during the speech;

determining highlights of the speech according to the length and density of the response information;

determining information about speakers corresponding to the highlights of the speech; and

taking a speaker with the most highlights of the speech as a core speaker.

In one exemplary embodiment of the present disclosure, the method further comprises: after the generation of a corresponding relationship between the speech contents of the different speakers and the identity information about the speakers, the method further comprises:

editing the speech contents of the different speakers; and

merging speech contents corresponding to the same speaker in a multi-person speech, so as to generate an audio file corresponding to each speaker.

In one exemplary embodiment of the present disclosure, the method further comprises: after the generation of a corresponding relationship between the speech contents of the different speakers and the identity information about the speakers, the method further comprises:

analyzing the relevancy between the speech contents of each speaker and the conference theme;

determining the social status and position information of the speakers and the total time length of the speech;

setting weight values for the relevancy, the total time length of the speech, the social status and the position information; and

according to at least one of the speech contents, the total time length of the speech, the social status and the position information of the speakers as well as the corresponding weight values, determining the order in which the edited audio files are stored/presented.

In one exemplary embodiment of the present disclosure, the method further comprises: after the generation of a corresponding relationship between the speech contents of the different speakers and the identity information about the speakers, the method further comprises:

taking the identity information about the speaker as an audio index/catalog; and

adding the audio index/catalog to a progress bar in a multi-person speech file.

In one aspect of the present disclosure, a speaker identification apparatus in a multi-person speech is provided, the apparatus comprising:

a harmonics acquisition module for acquiring speech contents in a multi-person speech, extracting a voice segment of a pre-set length from the speech contents, and performing de-fundamental wave processing on the voice segment to obtain a harmonics band of the voice segment;

a harmonics detection module for detecting the harmonics band in the voice segment of the pre-set length, calculating the number of harmonics during the detection, and analyzing the relative strengths of the various harmonics;

a speaker mark module for marking voices that have the same number of harmonics and the same strength of harmonics in different detection periods to be of the same speaker;

an identity information identification module for identifying, by analyzing speech contents corresponding to different speakers, identity information about each of the speakers; and

a corresponding relationship generation module for generating a corresponding relationship between the speech contents of the different speakers and the identity information about the speakers.

In one aspect of the present disclosure, an electronic device is provided, the electronic device comprising:

a processor; and

a memory storing computer readable instructions thereon that, when executed by the processor, implement the method according to any of the above.

In one aspect of the present disclosure, a computer readable storage medium is provided, which stores a computer program thereon that, when executed by a processor, implements the method according to any of the above.

In the exemplary embodiments of the present disclosure, the speaker identification method in a multi-person speech comprises: acquiring speech contents in a multi-person speech; extracting and processing a harmonics band in a voice segment of a pre-set length from the speech contents; making a calculation and analysis of the number of harmonics in the harmonics band and their relative strengths so as to determine the same speaker accordingly; identifying, by analyzing speech contents corresponding to different speakers, identity information about each of the speakers; and finally generating a corresponding relationship between the speech contents of the different speakers and the identity information about the speakers. In one aspect, because the number of harmonics and their relative strengths are used to calculate and analyze the same speaker, the accuracy of identifying speakers according to the timbre is improved. In the other aspect, by analyzing pronunciation contents to obtain identity information about a speaker, and establishing a corresponding relationship between the speech contents and the identity of the speaker, the use effect is greatly improved and the user experience is enhanced.

It should be understood that the general description above and the description of details below are merely exemplary and explanatory, but not to limit the present disclosure.

### BRIEF DESCRIPTION OF THE DRAWINGS

The above and other features and advantages in the present disclosure will become more apparent by describing, in detail, the exemplary embodiments thereof with reference to the accompanying drawings.

FIG. 1 shows a flowchart of a speaker identification method in a multi-person speech according to an exemplary embodiment of the present disclosure;

FIG. 2 shows a schematic block diagram of a speaker identification apparatus in a multi-person speech according to an exemplary embodiment of the present disclosure;

FIG. 3 schematically shows a block diagram of an electronic device according to an exemplary embodiment of the present disclosure; and

FIG. 4 schematically shows a schematic diagram of a computer readable storage medium according to an exemplary embodiment of the present disclosure.

### DETAILED DESCRIPTION OF EMBODIMENTS

The present disclosure will now be described more fully hereinafter with reference to the accompanying drawings, in which exemplary embodiments of the present disclosure are shown. The present disclosure may, however, be embodied in many different forms and should not be construed as limited to the embodiments set forth herein. Rather, these embodiments are provided so that this disclosure is thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting and/or capital letters has no influence on the scope and meaning of a term; the scope and meaning of a term are the same, in the same context, whether or not it is highlighted and/or in capital letters. It is appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only and in no way limits the scope and meaning of the invention or of any exemplified term. Likewise, the invention is not limited to various embodiments given in this specification.

It is understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It is understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below can be termed a second element, component, region, layer or section without departing from the teachings of the present disclosure. It is understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It are also appreciated by those of skill in the art that references to a structure or feature that is disposed “adjacent” to another feature may have portions that overlap or underlie the adjacent feature.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It is further understood that the terms “comprises” and/or “comprising,” or “includes” and/or “including” or “has” and/or “having” when used in this specification specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the figures. It is understood that relative terms are intended to encompass different orientations of the device in addition to the orientation shown in the figures. For example, if the device in one of the figures is turned over, elements described as being on the “lower” side of other elements would then be oriented on the “upper” sides of the other elements. The exemplary term “lower” can, therefore, encompass both an orientation of lower and upper, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below. Unless otherwise defined, all terms (including technical and scientific terms) used herein have the same meaning as commonly understood by one of ordinary skill in the art to which the present disclosure belongs. It is further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around,” “about,” “substantially” or “approximately” shall generally mean within 20 percent, preferably within 10 percent, and more preferably within 5 percent of a given value or range. Numerical quantities given herein are approximate, meaning that the terms “around,” “about,” “substantially” or “approximately” can be inferred if not expressly stated.

As used herein, the terms “comprise” or “comprising,” “include” or “including,” “carry” or “carrying,” “has/have” or “having,” “contain” or “containing,” “involve” or “involving” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be executed in different order (or concurrently) without altering the principles of the invention.

Embodiments of the invention are illustrated in detail hereinafter with reference to accompanying drawings. It should be understood that specific embodiments described herein are merely intended to explain the invention, but not intended to limit the invention. The disclosure will now be described in details in connection with the embodiments. The following embodiments are intended for facilitating those skilled in the art to understand the present disclosure, instead of limiting the present disclosure in any way. It should be noted that a number of variations and modifications may be made by those skilled in the art without departing from the inventive concept, all of which fall within the scope of protection of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor. The term “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The term “interface”, as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

In the present disclosure, computer components may include physical hardware components and virtual software components. One of ordinary skill in the art would appreciate that, unless otherwise indicated, these computer components may be implemented in, but not limited to, the forms of software, firmware or hardware components, or a combination thereof.

The apparatuses, systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The exemplary embodiments will now be described more fully with reference to the accompanying drawings. However, the exemplary embodiments can be implemented in many forms and should not be construed as being limited to the embodiments set forth herein; rather, these embodiments are provided so that the present disclosure will be thorough and complete, and will fully convey the concept of the exemplary embodiments to those skilled in the art. Like reference numerals in the drawings denote like or similar parts, and thus the repeated description thereof will be omitted.

Furthermore, the described features, structures, or characteristics may be combined in any suitable manner in one or more embodiments. In the following description, numerous specific details are provided, thereby giving a full understanding of the embodiments of the present disclosure. However, those skilled in the art will appreciate that the technical solution of the present disclosure can be practiced without one or more of the specific details, or other methods, components, materials, apparatuses, steps, etc can be adopted. In other circumstances, well-known structures, methods, apparatuses, implementations, materials or operations are not shown or described in detail to avoid obscuring the aspects of the present disclosure.

The block diagrams shown in the accompanying drawings are merely functional entities, which do not necessarily correspond to physically independent entities. That is, these functional entities can be implemented in the form of software, or these functional entities or some of the functional entities are implemented in one or more software-hardened modules, or these functional entities are implemented in different networks and/or processor apparatuses and/or micro-controller apparatuses.

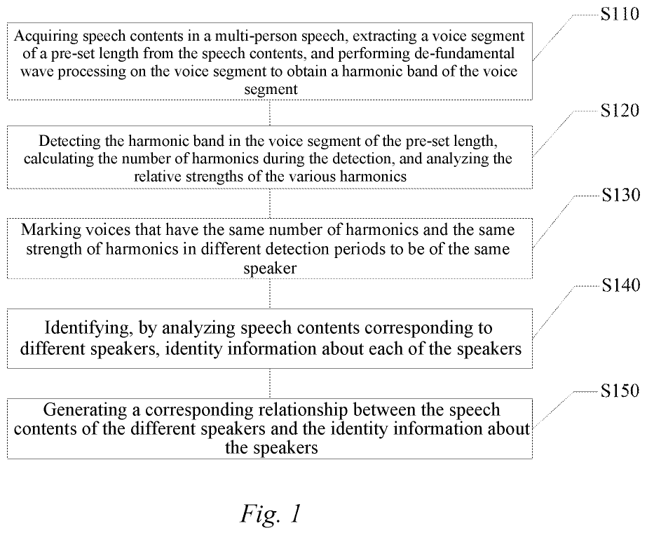

In this exemplary embodiment, a speaker identification method in a multi-person speech is first provided, which can be applied to an electronic device such as a computer. With reference to FIG. 1, the speaker identification method in a multi-person speech comprises the following steps:

step S110, acquiring speech contents in a multi-person speech, extracting a voice segment of a pre-set length from the speech contents, and performing de-fundamental wave processing on the voice segment to obtain a harmonics band of the voice segment;

step S120, detecting the harmonics band in the voice segment of the pre-set length, calculating the number of harmonics during the detection, and analyzing the relative strengths of the various harmonics;

step S130, marking voices that have the same number of harmonics and the same strength of harmonics in different detection periods to be of the same speaker;

step S140, identifying, by analyzing speech contents corresponding to different speakers, identity information about each of the speakers; and

step S150, generating a corresponding relationship between the speech contents of the different speakers and the identity information about the speakers.

According to the speaker identification method in a multi-person speech in this exemplary embodiment, in one aspect, because the number of harmonics and their relative strengths are used to calculate and analyze the same speaker, the accuracy of identifying speakers according to the timbre is improved. In the other aspect, by analyzing pronunciation contents to obtain identity information about a speaker, and establishing a corresponding relationship between the speech contents and the identity of the speaker, the use effect is greatly improved and the user experience is enhanced.

The speaker identification method in a multi-person speech in this exemplary embodiment will be further described below.

In step S110, it is possible to acquire speech contents in a multi-person speech, extracting a voice segment of a pre-set length from the speech contents, and performing de-fundamental wave processing on the voice segment to obtain a harmonics band of the voice segment.

In this exemplary embodiments, the speech contents in the multi-person speech can be audio and video contents received in real time during the speech or audio and video files recorded in advance. If the speech content in the multi-person speech is a video file, an audio part in the video file can be extracted, and the audio part is the speech content in the multi-person speech.

After the acquisition of the speech content in the multi-person speech, the speech content can be firstly subjected to Fourier transform, the filtering of an auditory filter bank and other ways to complete language filtering, so as to perform de-noising processing on the speech content. Next, a voice segment of a pre-set length in the speech content can be extracted regularly or in real time for voice analysis. For example, when the voice segment in the speech content is extracted regularly, it can be set to extract a voice segment of a time length of 1 ms every 5 ms as a processing sample, and when the frequency at which the sample is extracted regularly is higher, the voice segment of the pre-set length at which the sample is extracted is longer, and the probability of identifying the speaker is greater.

Speech sound wave is generally composed of a fundamental frequency sound wave and higher harmonics, the fundamental frequency sound wave has the same main frequency as that of the speech sound wave, and the effective speech content is carried by the fundamental frequency sound wave. Different vocal cords and vocal cavity structures of different speakers result in different timbre, that is, each speaker is different in terms of frequency characteristics in sound wave, especially the difference in harmonics band characteristics. Then, after a pre-set voice segment is extracted, it is possible to perform de-fundamental wave processing on the voice segment, so as to remove the fundamental frequency sound wave from the voice segment, thereby obtaining higher harmonics in the voice segment, i.e. a harmonics band.

In step S120, it is possible to detect the harmonics band in the voice segment of the pre-set length, calculate the number of harmonics during the detection, and analyze the relative strengths of the various harmonics.

In this exemplary embodiment, the harmonics band is the remaining higher harmonics after the fundamental frequency sound wave is removed from the voice segment, and the number of higher harmonics and the relative strengths of the harmonics in the same detection time are counted as the basis for determining whether voices in different detection periods belong to the same speaker. The number of higher harmonics and the relative strengths of the harmonics in harmonics bands of voices of different speakers are quite different, and the difference is also called vocal print. In a certain length of harmonics band, the number of higher harmonics and the relative strengths of the harmonics constitute a vocal print which can be the same as a fingerprint or an iris pattern as an unique identifier for different identities, and therefore, it is highly accurate to use the number of higher harmonics in a harmonics band and the differences among the relative strengths of the harmonics to identify different speakers.

In step S130, it is possible to mark voices that have the same number of harmonics and the same strength of harmonics in different detection periods to be of the same speaker.

In this exemplary embodiment, if the number of harmonics in a harmonics band and the strengths of the harmonics in different detection periods are the same or highly similar in a certain range, it can be presumed that the voices in the detection periods belong to the same speaker. Therefore, after the determination of the number and the strengths of harmonics in the harmonics bands in different detection periods in various voice segment in step S120, speeches that have the same number and the strengths of harmonics bands in the voice segments can be marked to be of the same speaker.

In the detection period, the voices with the same harmonics property can appear continuously in an audio, and can also appear intermittently.

In step S140, it is possible to identify, by analyzing speech contents corresponding to different speakers, identity information about each of the speakers.

In this exemplary implementation, identifying, by analyzing speeches corresponding to different speakers, identity information about each of the speakers comprises: muting the speeches of the different speakers and cutting same; framing the speeches of the different speakers at a pre-set frame length and a pre-set length of frame shifts, so as to obtain a voice fragment of a pre-set frame length; and using a Hidden Markov model:

Hidden Markov model λ=(A, B, π), (where A is an implicit state transition probability matrix;

B is an observation state transition probability matrix; and

π is an initial state probability matrix)

to extract acoustic features of the voice segment, so as to identify word features that have the identity information. In this exemplary embodiment, other voice recognition models can also be used to identify word features with the identity information, which is not specifically limited by the present application.

In this exemplary embodiment, speeches of different speakers are input into a voice recognition model so as to identify word features that have the identity information, a semantic analysis is performed on the word features that have the identity information in combination with a sentence that the word features are in, so as to determine identify information about the current speaker or speakers in other time periods, for example:

in a conference, some speaker spoke: “Hello, I'm Dr. Zhang Ming from Tsinghua University . . . ”. Firstly, the speaker's voice is processed by means of a voice recognition algorithm, and the word features with identity information are parsed and identified by means of the voice recognition model: “I'm”, “Tsinghua University”, “Zhang”, and “Dr.”. A semantic analysis is performed on the word features that have identity information in combination with a sentence that the word features are in, rules, such as, at which the word between the last name and the identity is the first name of the speaker, thereby determining that identify information about the current speaker is: “Organization: Tsinghua university”, “Name: Zhang Ming”, “Academic degree: Doctor” and other information.

In this exemplary embodiment, speeches of different speakers are input into a voice recognition model so as to identify word features that have identity information, and information about speakers in other time periods can also be known through the speeches of the current speaker, for example:

in a conference, a host spoke: “Hello everyone, please welcome Dr. Zhang Ming from Tsinghua University to make a speech . . . ”. Then, the speaker's voice is still firstly processed by means of a voice recognition algorithm, and then word features with identity information are parsed and identified by means of the voice recognition model: “please welcome . . . to make a speech”, “Tsinghua University”, “Zhang”, and “Dr.”. A semantic analysis is performed on the word features that have identity information in combination with a sentence that the word features are in, rules, such as, at which the word between the last name and the identity is the first name of the speaker, thereby determining that identify information about a speaker in the next speaker audio is: “Organization: Tsinghua university”, “Name: Zhang Ming”, “Academic degree: Doctor” and other information. As such, it can be known from the speech of the current host that the next speaker to speak is “Dr. Zhang Ming from Tsinghua University”, and after the detection of the current voice segment or the next voice segment, it is determined that the speaker has changed according to the change in the timbre in the speech, and then it can be known that the speaker after change is “Dr. Zhang Ming from Tsinghua University”.

In this exemplary embodiment, it is possible to search on the Internet for voice files that have the same number of harmonics and strength of harmonics as those of the speaker in the detection period, and search for bibliographic information about the voice files, and determining identity information about the speaker according to the bibliographic information. Especially in the case of processing audio with strong melody such as music or musical instrument playing, the method is easier to find the information about the corresponding speaker on the Internet. The method can be used as an auxiliary method for determining information about a speaker if identity information about the speaker cannot be analyzed and found in a speech content.

In step S150, it is possible to generate a corresponding relationship between the speech contents of the different speakers and the identity information about the speakers.

In this exemplary embodiment, after the identity information about each speaker is identified, a corresponding relationship between the corresponding audio of the speaker's speech content and all the identity information about the speaker is established.

In this exemplary embodiment, after the corresponding relationship between the speech contents of different speakers and the identity information about the speakers are generated, the speech contents of the different speakers are edited, and the speech contents corresponding to the same speaker in a multi-person speech are merged, so as to generate an audio file corresponding to each speaker.

In this exemplary embodiment, after the identity information about the speakers is identified, it is determined, by searching on the Internet for the social status and position corresponding to the speakers and according to the social status and position of the speakers, a speaker who has the highest matching degree with the current conference theme to be a core speaker.

For example, in a conference, after the identity information about the speakers is identified, it is found, by searching on the Internet for the social status and position of the speakers, that two speakers are “academicians”. Further, one of them is a “Nobel Prize winner”, in addition, the theme of this conference is “Nobel speech” and the speech time length of that “Nobel Prize winner” speaker is longer than the average speech time length of speakers, and then it is determined that the “Nobel Prize winner” speaker is the core speaker in this audio and video, and the identity information about the core speaker is labeled as a catalog or an index.

In this exemplary embodiment, after the identity information about the speakers is identified, response information during the speech is collected, highlights of the speech are determined according to the length and density of the response information, speaker information corresponding to the highlights of the speech is determined, and a speaker with the most highlights of the speech is taken as a core speaker.

The response information in the speech process can be applauses, cheers, etc. of the audience or participants.

For example, in a conference, after the identity information about various speakers is identified, if it is determined that there are five speakers in total to make a speech in this conference, the applauses during the speech of the speakers in this conference are collected, the duration and intensity of all the applauses are recorded, and the applauses during the speech are associated with the speakers. Thereafter, the length and intensity of the applauses during the speech of the speakers are analyzed, and the applauses longer than a pre-set time length (such as 2s) are marked as effective applauses, the number of effective applauses in each speaker's speech period is counted, the speaker with the most effective applauses is selected as the core speaker, and the identity information about the core speaker is labeled as a catalog or an index.

In this exemplary embodiment, after the corresponding relationship between the speech contents of different speakers and the identity information about the speakers are generated, the relevancy between the speech contents of each speaker and the conference theme is analyzed; the social status and position information of each speaker and the total time length of the speech are determined; the relevancy, the total time length of the speech, the social status and the position information are assigned with weight values; and the order in which the edited audio files are stored/presented is determined according to at least one of the speech contents, the total time length of the speech, the social status and the position information of the speakers and the corresponding weight values.

For example, in a conference audio, after the identity information about various speaker is identified, it is determined that there are three speakers, respectively being teacher Zhang, teacher Wang and teacher Zhao, and with weight values of the social status, the total time length of the speech and the relevancy of each speaker being:

TABLE 1

| | | | | Speech time | | | |
|---|---|---|---|---|---|---|---|
| | | Social Status | | length | | Relevancy | |
| | | Weight | | Weight | | Weight | Sum of |
| | Social Status | Coefficient: | Speech Time | Coefficient: | | Coefficient: | Weight |
| | Score | 1 | length | 0.3 | Relevancy | 0.6 | values |
| Teacher | Senior | 10 | 30 | 9 | Number of | 12 | 31 |
| Zhang | Teacher = | | minutes | | Keywords = | | |
| | 10 | | | | 20 | | |
| Teacher | Senior | 10 | 50 | 15 | Number of | 18 | 43 |
| Wang | Teacher = | | minutes | | Keywords = | | |
| | 10 | | | | 30 | | |
| Teacher | Intermediate | 7 | 30 | 9 | Number of | 6 | 22 |
| Zhao | Teacher = | | minutes | | Keywords = | | |
| | 7 | | | | 10 | | |

It can be seen from Table 1 that teacher Wang is determined as the core speaker because the sum of his or her weight values is the largest, followed by teacher Zhang and teacher Zhao in order, and therefore, the order in which the edited audio files are stored/presented is: “1. teacher Wang's audio.mp3”, “2. teacher Zhang's audio.mp3”, “3. teacher Zhao's audio.mp3”.

It should be noted that although the steps of the method in the present disclosure are described in a specific order in the accompanying drawings, this does not require or imply that these steps must be performed in that specific order or that all the steps shown must be performed to achieve the desired result. Additionally or alternatively, some steps can be omitted, a plurality of steps can be combined into one step for execution, and/or one step is decomposed as a plurality of steps for execution, etc.

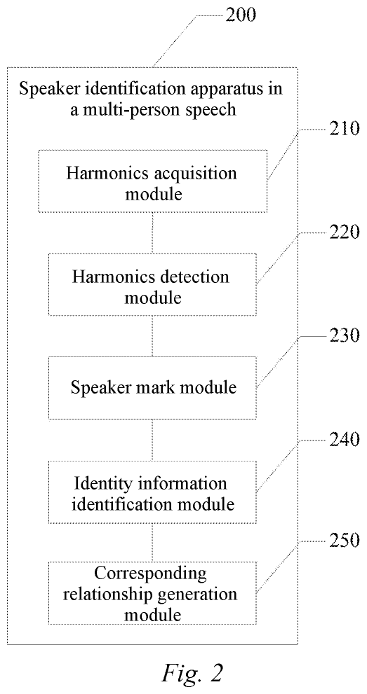

Furthermore, in this exemplary embodiment, a speaker identification apparatus in a multi-person speech is also provided. With reference to FIG. 2, the audio segment identification apparatus 200 can comprise: a harmonics acquisition module 210, a harmonics detection module 220, a speaker mark module 230, an identity information identification module 240 and a corresponding relationship generation module 250.

The harmonics acquisition module 210 is used for acquiring speech contents in a multi-person speech, extracting a voice segment of a pre-set length from the speech contents, and performing de-fundamental wave processing on the voice segment to obtain a harmonics band of the voice segment.

The harmonics detection module 220 is used for detecting the harmonics band in the voice segment of the pre-set length, calculating the number of harmonics during the detection, and analyzing the relative strengths of the various harmonics.

The speaker mark module 230 is used for marking voices that have the same number of harmonics and the same strength of harmonics in different detection periods to be of the same speaker.

The identity information identification module 240 is used for identifying, by analyzing speech contents corresponding to different speakers, identity information about each of the speakers.

The corresponding relationship generation module 250 is used for generating a corresponding relationship between the speech contents of the different speakers and the identity information about the speakers.

The specific details about various modules in the speaker identification apparatus in a multi-person speech described above have been described in detail in the corresponding audio segment identification method, and will be omitted for brevity here.

It should be noted that although several modules or units of the speaker identification apparatus 200 in a multi-person speech are mentioned in the above detailed description, this division is not mandatory. In fact, according to the embodiments of the present disclosure, the features and functions of two or more modules or units described above may be embodied in one module or unit. On the contrary, the features and functions of a module or unit described above can be further divided so as to be embodied by multiple modules or units.

Furthermore, in an exemplary embodiment of the present disclosure, an electronic device capable of implementing the above method is also provided.

A person of ordinary skill in the art will appreciate that various aspects of the present invention can be realized as a system, a method or a program product. Therefore, various aspects of the present invention can be specifically realized in the following form, that is: an entire hardware embodiment, an entire software embodiment (including firmware, microcodes, etc.), or an embodiment combining hardware and software that can be collectively referred to as “a circuit”, “a module” or “a system” herein.

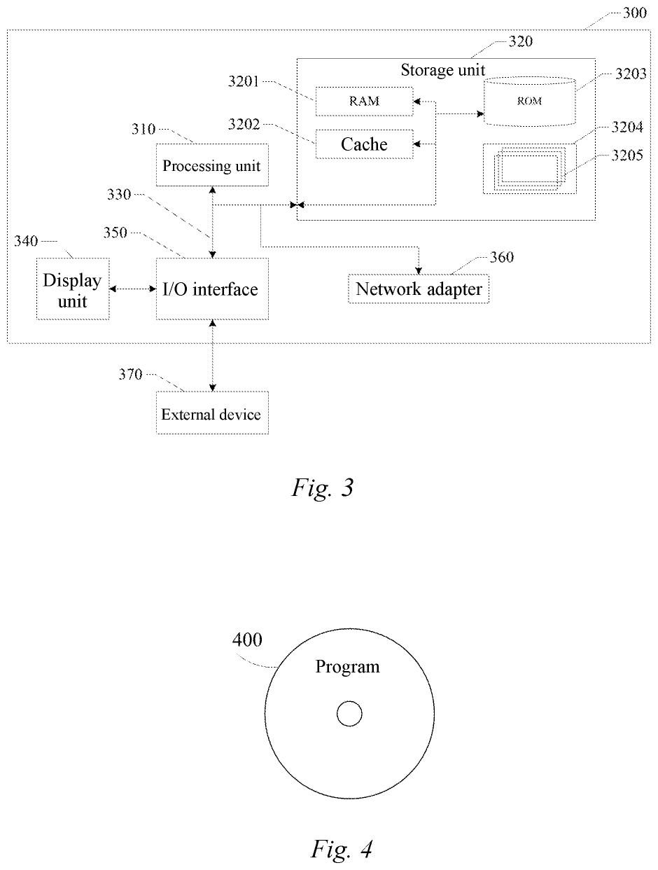

An electronic device 300 according to this embodiment of the present invention is described below with reference to FIG. 3. The electronic device 300 shown in FIG. 3 is merely an example and shall not impose any limitations on the function and scope of use of the embodiments of the present invention.

As shown in FIG. 3, the electronic device 300 is embodied in the form of a general-purpose computing device. Components of the electronic device 300 may include but not limited to: at least one processing unit 310 mentioned above, at least one storage unit 320 mentioned above, a bus 330 for connecting to different system components (including the storage unit 320 and the processing unit 310), and a display unit 340.

The storage unit stores program codes that can be executed by the processing unit 310 so that the processing unit 310 performs the steps described in the “Exemplary Method” section above of this description according to various exemplary embodiments of the present invention. For example, the processing unit 310 can perform steps S110 through S130 as shown in FIG. 1.

The storage unit 320 may include a readable media in the form of a volatile storage unit, such as a random access memory (RAM) 3201 and/or a cache storage unit 3202, and may also further include a read-only memory (ROM) 3203.

The storage unit 320 may also include a program/utility tool 3204 having a set of (at least one) program modules 3205, such a program module 3205 including but not limited to: an operating system, one or more application programs, other program modules and program data, wherein each of or some combination of these examples may include an implementation of a network environment.

The bus 330 may represent one or more of several types of bus structures, including a storage unit bus or a storage unit controller, a peripheral bus, a graphics acceleration port, a processing unit, or a local bus that uses any of the several bus structures.

The electronic device 300 can also communicate with one or more external devices 370 (such as a keyboard, a pointing device, a Bluetooth device, etc.), can also communicate with one or more devices that enable a user to interact with the electronic device 300, and/or communicate with any device (such as a router, a modem, etc.) that enables the electronic device 300 to communicate with one or more other computing devices. This communication can be carried out through an input/output (I/O) interface 350. Also, the electronic device 300 can also communicate with one or more networks (such as a local area network (LAN), a wide area network (WAN), and/or a public network (such as the Internet)) through a network adapter 360. As shown in the figure, the network adapter 360 communicates with other modules of the electronic device 300 via the bus 330. It should be understood that although not shown in the figure, other hardware and/or software modules may be used in conjunction with the electronic device 300, including but not limited to: microcodes, a device drive, a redundancy processing unit, an external disk drive array, an RAID system, a tape drive, and a data backup and storage system, etc.

Through the description of the above embodiments, it is easy for those skilled in the art to understand that the exemplary embodiments described herein can be realized by software or by combining software with necessary hardware. Therefore, the technical solution according to the embodiments of the present disclosure may be embodied in the form of a software product, and the software product can be stored on a non-volatile storage medium (which may be a CD-ROM, USB flash disk, a removable hard disk, etc.) or on a network, comprising several instructions to enable a computing device (which may be a personal computer, a server, a terminal apparatus, or a network device, etc.) to perform the method according to the embodiments of the present disclosure.

In an exemplary embodiment of the present disclosure, a computer readable storage medium is also provided, on which a program product capable of implementing the method described in the description is stored. In some possible embodiments, various aspects of the present invention may also be embodied in the form of a program product, which comprises program codes for causing, when the program product is running on a terminal device, the terminal device to perform the steps described in the “Exemplary Method” section of this description above according to various exemplary embodiments of the present invention.

With reference to FIG. 4, a program product 400 for realizing the method above according to an embodiment of the present invention is described, which can use a portable compact disk read-only memory (CD-ROM) and include program codes, and can run on a terminal device, such as a personal computer. However, the program product of the present invention is not limited thereto. In this document, the readable storage medium may be any tangible medium containing or storing a program that can be used by or in combination with an instruction execution system, an apparatus or a device.

The program product may take any combination of one or more readable media. The readable medium may be a readable signal medium or a readable storage medium. The readable storage media may, for example, be but not limited to an electric, magnetic, optical, electromagnetic, infrared or semiconductor system, apparatus or device, or any combination of the above. More specific examples of the readable storage media (non-exhaustive list) include: an electrical connection having one or more wires, a portable disk, a hard disk, a random access memory (RAM), a read-only memory (ROM), an erasable programmable read-only memory (EPROM or FLASH), an optical fiber, a portable compact disk read-only memory (CD-ROM), an optical storage device, a magnetic storage device, or any suitable combination of the above.

A computer readable signal medium may include a data signal propagated in a baseband or as part of a carrier, which carries readable program codes. Such a propagated data signal may take a variety of forms, including, but not limited to, an electromagnetic signal, an optical signal or any suitable combination of the above. The readable signal medium may also be any readable medium other than the readable storage medium, which may send, propagate or transmit a program for use by or in combination with an instruction execution system, an apparatus or a device.

The program codes contained on the readable medium may be transmitted over any appropriate medium, including but not limited to wireless, wired, optical cable, RF, etc., or any suitable combination of the above.

The program code for performing the operation of the present invention may be written in any combination of one or more programming languages, including object-oriented programming languages such as Java, C++, and also including conventional procedural programming languages such as “C” language or similar programming languages. The program code can be executed entirely on a user computing device, partially on a user device, as a separate software package, partially on a user computing device and partially on a remote computing device, or completely on a remote computing device or a server. In the case of a remote computing device, the remote computing device can be connected to a user computing device over any type of network, including a local area network (LAN) or a wide area network (WAN), or can be connected to an external computing device (for example, using an Internet service provider to connect over the Internet).

Furthermore, the accompanying drawings above are merely schematic illustrations of the processing included in the method according to exemplary embodiments of the present invention, but not for purposes of limitation. It is easy to understand that the processing shown in the accompanying drawings above do not indicate or limit the chronological order of the processing. Additionally, it is also easy to understand that the processing can be performed, for example, synchronously or asynchronously in multiple modules.

After consideration of the description and practice of the invention disclosed herein, other embodiments of the present disclosure will readily occur to a person skilled in the art. The present application is intended to cover any variations, usages or adaptive changes of the present disclosure, and these variations, usages or adaptive changes follow the general principles of the present disclosure and include common knowledge or customary technical means in the technical field that are not disclosed the present disclosure. The description and embodiments are merely considered as exemplary and the true scope and spirit of the present disclosure are indicated by the claims.

It is to be understood that the present disclosure is not limited to the exact structure described above and shown in the accompanying drawings, and various modifications and changes may be made without departing from the scope of the present disclosure. The scope of the present disclosure is limited merely by the appended claims.

### INDUSTRIAL APPLICABILITY

In one aspect, because the number of harmonics and their relative strengths are used to calculate and analyze the same speaker, the accuracy of identifying speakers according to the timbre is improved. In the other aspect, by analyzing pronunciation contents to obtain identity information about a speaker, and establishing a corresponding relationship between the speech contents and the identity of the speaker, the use effect is greatly improved and the user experience is enhanced.

The foregoing description of the exemplary embodiments of the present invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

1. A speaker identification method in a multi-person speech, comprising:
acquiring speech contents in a multi-person speech, extracting a voice segment of a pre-set length from the speech contents, and performing de-fundamental wave processing on the voice segment to obtain a harmonics band of the voice segment;
detecting the harmonics band in the voice segment of the pre-set length, calculating the number of harmonics during the detection, and analyzing the relative strengths of the various harmonics;
marking voices that have the same number of harmonics and the same strength of harmonics in different detection periods to be of the same speaker;
identifying, by analyzing speech contents corresponding to different speakers, identity information about each of the speakers; and
generating a corresponding relationship between the speech contents of the different speakers and the identity information about the speakers.

2. The method of claim 1, wherein identifying, by analyzing speeches corresponding to different speakers, identity information about each of the speakers comprises:
inputting the speeches of the different speakers into a voice recognition model so as to identify word features that have the identity information; and
performing semantic analysis on the word features that have the identity information in combination with a sentence that the word features are in, so as to determine identify information about the current speaker or speakers in other time periods.

3. The method of claim 2, wherein inputting the speeches of the different speakers into a voice recognition model so as to identify word features that have the identity information comprises:
muting the speech audio of the different speakers and cutting same;
framing the speeches of the different speakers at a pre-set frame length and a pre-set length of frame shifts, so as to obtain a voice segment of a pre-set frame length; and
extracting acoustic features of the voice segment by using a Hidden Markov model λ=(A, B, π), so as to identify the word features that have the identity information, where A is an implicit state transition probability matrix; B is an observation state transition probability matrix; and t is an initial state probability matrix.

4. The method of claim 1, wherein identifying, by analyzing speeches corresponding to different speakers, identity information about each of the speakers comprises:
searching, on the Internet, for voice files that have the same number of harmonics and strength of harmonics as those of the speaker in the detection period; and
searching for bibliographic information about the voice files, and determining identity information about the speaker according to the bibliographic information.

5. The method of claim 1, wherein after the identification of the identity information about the various speakers, the method further comprises:
searching, on the Internet, for the social status and position corresponding to the various speakers; and
according to the social status and position of the speakers, determining a speaker who has the highest matching degree with the current conference theme to be a core speaker.

6. The method of claim 1, wherein the method further comprises:
collecting response information during the speech;
determining highlights of the speech according to the length and density of the response information;
determining information about speakers corresponding to the highlights of the speech; and
taking a speaker with the most highlights of the speech as a core speaker.

7. The method of claim 1, wherein after the generation of a corresponding relationship between the speech contents of the different speakers and the identity information about the speakers, the method further comprises:
editing the speech contents of the different speakers; and
merging speech contents corresponding to the same speaker in a multi-person speech, so as to generate an audio file corresponding to each speaker.

8. The method of claim 7, wherein after the generation of a corresponding relationship between the speech contents of the different speakers and the identity information about the speakers, the method further comprises:
analyzing the relevancy between the speech contents of each speaker and the conference theme;
determining the social status and position information of the speakers and the total time length of the speech;
setting weight values for the relevancy, the total time length of the speech, the social status and the position information; and
according to at least one of the speech contents, the total time length of the speech, the social status and the position information of the speakers as well as the corresponding weight values, determining the order in which the edited audio files are stored/presented.

9. The method of claim 1, wherein after the generation of a corresponding relationship between the speech contents of the different speakers and the identity information about the speakers, the method further comprises:
taking the identity information about the speaker as an audio index/catalog; and
adding the audio index/catalog to a progress bar in a multi-person speech file.

10. A speaker identification apparatus in a multi-person speech, comprising:
a harmonics acquisition module for acquiring speech contents in a multi-person speech, extracting a voice segment of a pre-set length from the speech contents, and performing de-fundamental wave processing on the voice segment to obtain a harmonics band of the voice segment;
a harmonics detection module for detecting the harmonics band in the voice segment of the pre-set length, calculating the number of harmonics during the detection, and analyzing the relative strengths of the various harmonics;
a speaker mark module for marking voices that have the same number of harmonics and the same strength of harmonics in different detection periods to be of the same speaker;
an identity information identification module for identifying, by analyzing speech contents corresponding to different speakers, identity information about each of the speakers; and
a corresponding relationship generation module for generating a corresponding relationship between the speech contents of the different speakers and the identity information about the speakers.

11. An electronic device, comprising:
a processor; and
a memory storing computer readable instructions thereon that, when executed by the processor, implement the method of claim 1.

12. A computer readable storage medium storing a computer program thereon that, when executed by a processor, implements the method of claim 1.
